(19) United States
(12) Patent Application Publication
(10) Pub. No.: US 2026/0326556 A1
(43) Pub. Date: Oct. 22, 2026

(54) PERSONALIZED PLANNING ASSISTANCE WITH CENTRAL AND LOCAL CONNECTED PLATFORMS

(71) Applicant: GM GLOBAL TECHNOLOGY OPERATIONS LLC, Detroit, MI (US)

(72) Inventors: Prakash M. Peranandam, Rochester Hills, MI (US); Paolo Giusto, Brentwood, CA (US); Venkata Naga Siva Vikas Vemuri, Farmington Hills, MI (US); Azin Neishaboori, Plymouth, MI (US); Arun Adiththan, Sterling Heights, MI (US)

(73) Assignee: GM GLOBAL TECHNOLOGY OPERATIONS LLC, Detroit, MI (US)

(21) Appl. No.: 19/184,244

(22) Filed: Apr. 21, 2025

(51) Int. Cl. B60K 35/28; G06F 21/62; G06Q 10/02; H04L 67/306

(52) U.S. Cl. CPC B60K 35/28; G06F 21/629; G06Q 10/02; H04L 67/306

(57) ABSTRACT

A system for providing personalized assistance to a user of a vehicle includes a controller installed in the vehicle and a central platform located remotely relative to the vehicle. The central platform is communicatively coupled to a plurality of local platforms having respective services. A mobile application is operable by the user and adapted to interface with the controller. The controller is adapted to transmit situational data to the central platform, which analyzes the situational data to determine one or more service recommendations for the user offered by the plurality of local platforms. The controller is adapted to receive the service recommendations from the central platform. The mobile application is adapted to solicit user input on the service recommendations. Access of the user to the service recommendations is facilitated by the controller based on the user input.

### INTRODUCTION

The present disclosure relates to a system and method for providing personalized planning assistance with a central platform and connected local platforms to a user in a vehicle. The number and variety of smart devices and connected systems have grown tremendously in recent times. Each device and system holds a respective piece of information which, when unified, creates a powerful tool to serve a user. However, the challenge lies in the connectivity—establishing seamless interactions between these devices, creating a platform that is both personalized to the user, and is customized in real-time.

### SUMMARY

Disclosed herein is a system for providing personalized assistance to a user of a vehicle. The system includes a controller installed in the vehicle, the controller having a processor and tangible, non-transitory memory on which instructions are recorded. A central platform is in communication with the controller. The central platform is located remotely relative to the vehicle, and is communicatively coupled to a plurality of local platforms having respective services. A mobile application is operable by the user and adapted to interface with the controller.

The controller is adapted to transmit situational data to the central platform, including at least one of vehicle location data, vehicle status data, user preference data, and usage history data. The central platform is adapted to analyze the situational data to determine one or more service recommendations (“one or more” omitted henceforth) for the user offered by the plurality of local platforms. The controller is adapted to receive the service recommendations from the central platform, with the mobile application being adapted to solicit user input on the service recommendations. Access of the user to the service recommendations is facilitated by the controller based on the user input.

In some embodiments, the plurality of local platforms include a charging station, a roadside unit, and a tolling unit. The plurality of local platforms may include a transportation hub, a lodging facility, and food service establishment. The plurality of local platforms may include a home system, a paid parking facility and another vehicle. The vehicle may include an infotainment unit with the mobile application being hosted by the infotainment unit.

In some embodiments, the controller is adapted to identify the user and obtain an associated user profile, extract trip details and personal requirements based in part on user input and/or historical data and confirm the trip details with the user. The controller may be adapted to identify a plurality of trip parameters, including at least one of toll avoidance, maximum waiting time, carpool constraints, and beverage pickup.

In some embodiments, the controller is adapted to extract one or more dependency relationships between the plurality of trip parameters through a large language model (LLM), determine presence of a user override factor, and select a respective optimal value for the plurality of trip parameters based on a user profile and the dependency relationships. The central platform may be adapted to communicate with the plurality of local platforms via a publish-subscribe messaging protocol, such as Message Queue Telemetry Transport (MQTT).

The controller may be adapted to solicit tasks to be accomplished within a predefined time from the user. The task sequencing for the tasks is performed using a large language model (LLM). In some embodiments, at least one of the tasks requires advanced booking and controller is adapted to make the advanced booking for the at least one of the tasks for the user via an electronic reservation protocol. The plurality of local platforms may include a home system having a regular climate setting and a vacation climate setting, with the controller being adapted to switch the home system to the vacation climate setting when the vehicle is a predefined distance away from the home system.

The plurality of local platforms may include a home system where the controller is adapted to selectively grant access privileges of the home system to a guest selected by the user. The access privileges may include access to at least one of a home Wi-Fi and front door access to the home system. The plurality of local platforms may include a rented lodging facility having a host, with the controller being adapted to receive electronic entrance access to the rented lodging facility from the host.

Disclosed herein is a method for providing personalized assistance to a user of a vehicle having an infotainment unit and a controller with a processor and tangible, non-transitory memory on which instructions are recorded. The method includes establishing bi-directional communication between a central platform and the controller, the central platform being located remotely relative to the vehicle. The central platform is communicatively coupled to a plurality of local platforms having respective services. The method includes hosting a mobile application with the infotainment unit, the mobile application being operable by the user.

The method includes transmitting situational data from the controller to the central platform, the situational data including at least one of vehicle location data, vehicle status data, user preference data, and usage history data. The method includes analyzing the situational data to determine one or more service recommendations for the user from the plurality of local platforms, via the central platform. The method includes receiving the one or more service recommendations from the central platform, via the controller, and soliciting user input for the one or more service recommendations, via the mobile application. The method includes facilitating access of the user to the one or more service recommendations, via the controller.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of a system for providing personalized planning assistance to a user in a vehicle, the vehicle having a controller;

FIG. 2 is a flowchart for an example method of operating the system of FIG. 1;

FIG. 3 is a flowchart for a portion of the method of FIG. 2; and

FIG. 4 is a flowchart for another portion of the method of FIG. 2.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

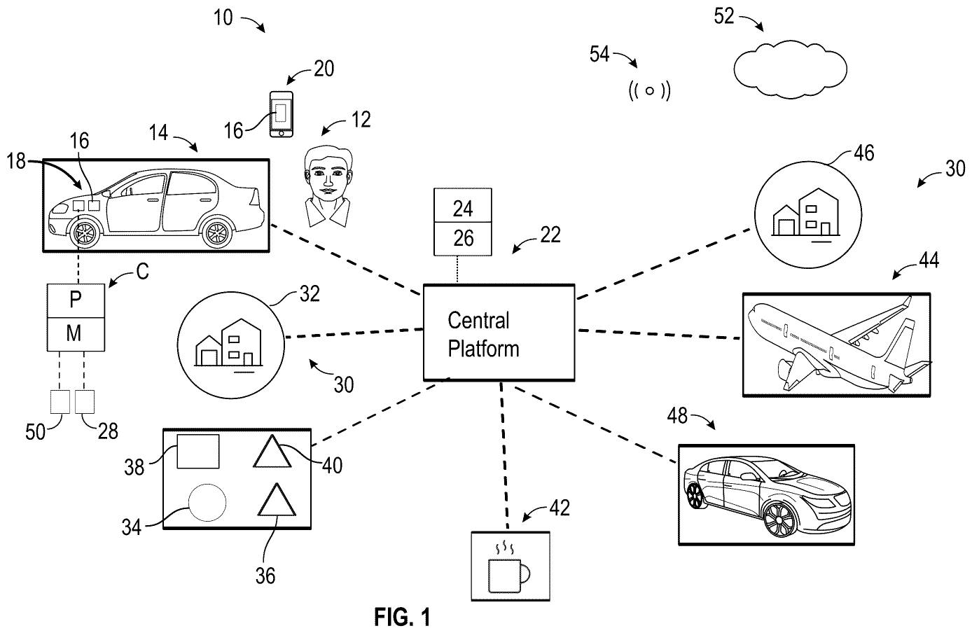

Referring to the drawings, wherein like reference numbers refer to like components, FIG. 1 schematically illustrates a system 10 for providing personalized assistance to a user 12 of a vehicle 14. The user 12 may be a driver or a passenger of the vehicle 14. The vehicle 14 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 14 may be a purely electric vehicle, a hybrid/partially electric vehicle, or have an internal combustion engine. The vehicle 14 may be an autonomous vehicle or a partially autonomous vehicle. It is to be understood that the vehicle 14 may take many different forms and have additional components.

In some embodiments, the system 10 may be automatically activated when the vehicle 14 is in operation, e.g., based on an observed event, trigger or received event. Alternatively, the system 10 may be selectively activated based on a request from the user 12, for example, through a mobile application 16, which may be hosted or executed on the infotainment unit 18 of the vehicle 14. The infotainment unit 18 may include a touchscreen or other IO device and may be incorporated in the dashboard, overhead visor (not shown), or other suitable location in the vehicle 14. The mobile application 16 may be hosted or executed on a smart device 20 (e.g., cell phone, tablet) of the user 12.

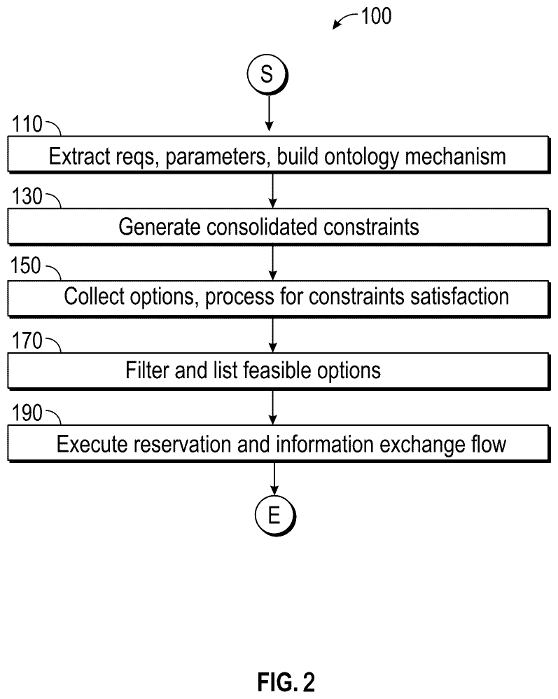

The system 10 provides intelligent planning, sequencing and routing capabilities by seamlessly connecting and collecting information from heterogenous local platforms, thus creating a personalized and optimized experience for the user 12 of the vehicle 14. Referring to FIG. 1, the vehicle 14 includes a controller C with at least one processor P and at least one memory M (or non-transitory, tangible computer readable storage medium) on which instructions are recorded for executing a method 100 of operating the system 10. Method 100 is described below with reference to FIG. 2. The memory M can store controller-executable instruction sets, and the processor P can execute the controller-executable instruction sets stored in the memory M.

Referring to FIG. 1, the system 10 includes a central platform 22 in communication with a plurality of local platforms 30 having respective resources. The controller C is adapted to transmit situational data to the central platform 22, including at least one of vehicle location data, vehicle status data, user preference data, and usage history data. The central platform 22 is adapted to analyze the situational data to determine one or more service recommendations for the user 12 from the plurality of local platforms 30. The central platform 22 may be adapted to receive periodic updates from heterogenous local platforms and devices to analyze and compute recommendations. It should be appreciated that there may be central platform-approved arrangements where heterogenous local platforms may directly update information to the service requestor (e.g., vehicle 14).

The controller C is adapted to receive service recommendations from the central platform 22. Referring to FIG. 1, the mobile application 16 may be used to solicit user input on the service recommendations. In some embodiments, the system 10 is executable in part by a respective controller C in each individual vehicle. In a fleet, the system 10 may be executable by a controller in a master vehicle. In some embodiments, the controller C may be adapted to receive information directly from the central platform 22 and/or local platforms 30 in order to analyze and compute the recommendations.

As described below, the system 10 involves extraction of user requirements from its own connected devices, personal details, historical data, and profile information. The central platform 22 and/or controller C is adapted to build constraints to identify information pertaining to other local platforms to present an optimal route, optimize travel cost, and a predefined user experience.

Referring to FIG. 1, the central platform 22 includes at least one processor 24 and at least one memory 26 (or non-transitory, tangible computer readable storage medium). Referring to FIG. 1, the vehicle 14 may employ a connectivity module 28 to send and receive information from the central platform 22. The central platform 22 operates as a back office, managing the overall process. The central platform 22 may include one or more servers hosted on the Internet to store, manage, and process data. The central platform 22 may be manned electronically and/or by an administrator having access to an electronic device such as a desktop computer, laptop, tablet, cell phone or wearable device. The central platform 22 may be a private or public entity maintained by an organization.

Each local platform 30 includes one or more connected devices or IoT devices. As understood by those skilled in the art, the internet of things (IoT) is a network of devices that may communicate with each other and with the cloud using the internet. For example, the connected device in a home local platform may include a garage door, wall mount charger, a front door, and a lighting system. The connected device in a smart city may include a parking spot. The vehicle 14 may be considered as an IoT device and/or IoT ecosystem. The system 10 may apply to other IoT devices and to a user 12 at home.

Examples of local platforms 30 are shown in FIG. 1. It is understood that the local platforms shown here are non-limiting examples and other types of platforms may be included. The local platforms 30 may include a smart home system 32, a paid parking facility 34 (e.g., commercial garage), a charging station 36, a roadside unit 38, and a tolling unit 40 (for collecting road tolls). The local platforms 30 may include a food service establishment 42 (e.g., restaurant or café), a transportation hub 44 (e.g., airport, a railway station, bus station etc.), and a lodging facility 46 (e.g., hotel, motel, vacation rental marketplace etc.) The local platforms 30 may include other vehicles 48.

Referring now to FIG. 2, a flowchart of an example method 100 of operating the system 10 is shown. Method 100 may be embodied as computer-readable code or instructions stored on and at least partially executable by the controller C and/or the central platform 22. Method 100 need not be applied in the specific order recited herein. Furthermore, it is to be understood that some blocks or steps may be eliminated.

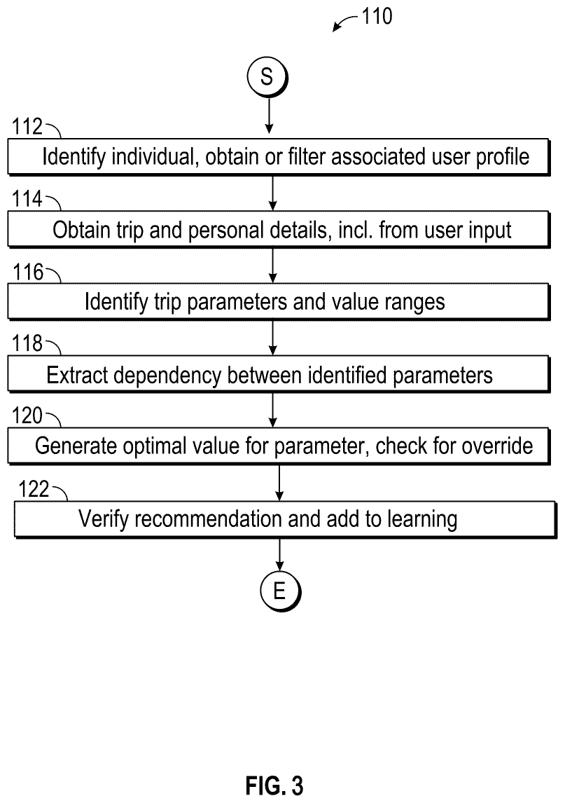

Beginning at block 110 of FIG. 2, the method 100 includes extracting requirements or trip parameters for the user 12 from a plurality of inputs including: a stored user profile, the destination, various tasks on the agenda of the user 12 (e.g., pick up kids, pick up coffee, purchase groceries etc.). Block 110 includes sub-blocks 112, 114, 116, 118, 120, 122, which are shown in and described below with respect to FIG. 3.

Advancing to block 130 of FIG. 2, method 100 includes generating a set of conditions, referred to herein as consolidated constraints, that shape the final recommendation. The predefined user profiles, personas, associated dependent parameters and preferences of the user 12 form the foundation for constraints generation within the system 10. This personalized approach ensures recommendations align with individual user requirements and expectations. The controller C may be adapted to feed these conditions for processing by a machine learning module 50.

In some embodiments, the machine learning module 50 may include a neural network trained using training datasets provided by the central platform 22. The training process occurs in a closed loop or iterative fashion, with the neural network being trained until a certain criteria is met, i.e., until the discrepancy between the network outcome and ground truth reaches a point below a certain threshold. As a predefined loss function related to the training dataset is minimized, the neural network reaches convergence. The convergence signals the completion of the training. The system 10 may be configured to be “adaptive” and updated periodically after the collection of additional training data for the machine learning module 50. It is to be understood that the system 10 is not limited to a specific neural network methodology.

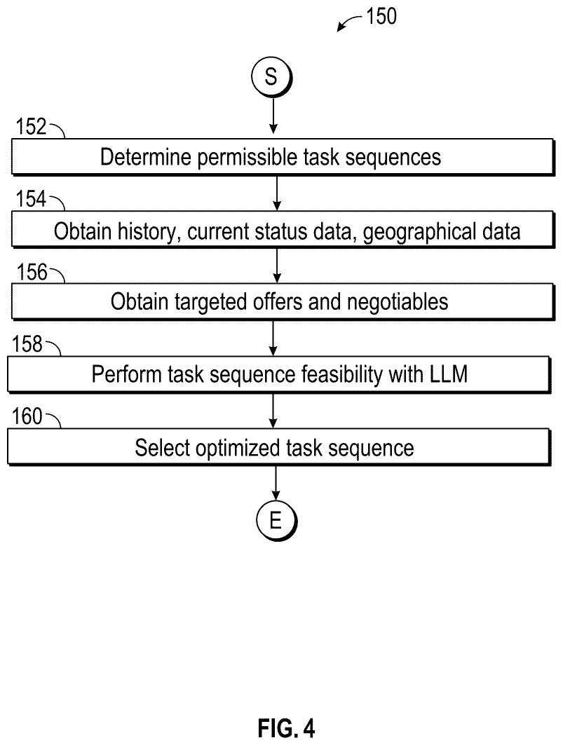

Advancing to block 150 of FIG. 2, method 100 includes collecting various options available to the user 12, and setting up a process for using those options to fit into the constraints obtained in the previous steps. In some embodiments, the access between the central platform 22 and the local platform is regulated by a subscription level control system. This allows the creation of tiered service offerings based on the subscription level of the user 12. The central platform 22 may be adapted to communicate with the plurality of local platforms 30 via a publish-subscribe messaging protocol. The publish/subscribe mechanism may include Message Queue Telemetry Transport (MQTT) or other mechanisms. The term “MQTT” includes variations and updates of MQTT. MQTT is a bi-directional communication protocol that allows the client devices and server application to become decoupled. The publish-subscribe messaging protocol may use an encryption model with certificate, username and password protected connections. Block 150 includes sub-blocks 152, 154, 156, 158, 160, which are shown in and described below with respect to FIG. 4. The attributes or textual constraints may be converted to a mathematical or Boolean expressions, along with the use of incremental constraint solvers and large language models.

Proceeding to block 170 of FIG. 2, the method 100 includes filtering the various options using the machine learning module 50, listing feasible options, and obtaining one or more service recommendations for the user 12 from the local platforms 30. This may include adding alternate options with some changes, or removing some options. For example, the user 12 may go to a different coffee shop or skip the coffee.

Advancing to block 190 of FIG. 2, method 100 includes facilitating access of the user 12 to the one or more service recommendations based on the user input. Per block 190, the controller C and/or the central platform 22 are adapted to execute an information exchange flow where the service information may be transmitted to applications for reservation or cancellation processes based on the user profiles. In some embodiments, if the tasks require advanced booking, the controller may be adapted to make the advanced booking for the tasks via an electronic reservation protocol.

Referring now to FIG. 3, an example flowchart of block 110 is shown. It is understood that block 110 need not be applied in the specific order recited herein. Furthermore, it is to be understood that some blocks or steps may be eliminated. Per sub-block 112, the method 100 includes identifying the user, for example through a vehicle camera and/or a key fob. The controller C and/or central platform 22 may download and filter associated user profiles for the user 12 from a cloud database 52. Per sub-block 114, the method 100 includes obtaining trip and personal details, either directly from the user 12 or from historical learning.

Per sub-block 116, the method 100 includes identifying each trip parameter for the trip (per sub-block 114) and assigning value ranges for each trip parameter. The trip parameters may include toll avoidance, a maximum waiting time, carpool constraints (having to pick up kids at a certain time), and beverage pickup. Per sub-block 118, the method 100 includes extracting dependency between identified parameters and building a structure or ontology between them via the machine learning module 50. For example, if the trip includes visiting the post office, picking up coffee, picking up a friend and going to the theater, the dependencies include start time, traffic, post office opening hours, location of coffee shop, friend and theater etc.

Per sub-block 120, the method 100 includes generating an optimal value for each trip parameter based on the user profile and persona, and checking to see if a user override issue has been flagged (e.g., a maximum waiting time flagged by the user 12). Per sub-block 122, the method 100 includes verifying the service recommendation, and adding it to the historical data, e.g., sending it to the cloud database 52.

Referring now to FIG. 4, an example flowchart of block 150 is shown. It is understood that block 150 need not be applied in the specific order recited herein. Furthermore, it is to be understood that some blocks or steps may be eliminated.

Per sub-block 152, the method 100 includes determining permissible task sequences. For example, if there are four tasks (clean car, pick up friend, get coffee, go to post office, final destination), the method 100 determines each of the possible sequences for performing the tasks.

Per sub-block 154, the method 100 includes obtaining historical data, such as the usual waiting time for coffee, post office closing time, and the typical wait time at the post office. The method 100 includes obtaining current status data (e.g., current wait time at the post office) and geographical data (e.g., road traffic at the location of the friend and at the post office).

Per sub-block 156, the method 100 includes obtaining targeted offers and negotiables. The central platform 22 may be adapted to deliver “Business to Business” services that allow companies to plan and target advertisements and offers to potential customers. For example, a business near the post office may be offering free or discounted coffee. This offer may be brought to the attention of the user 12.

Per sub-block 158, the method 100 includes performing task sequence feasibility with a large language model (LLM), which is a specific type of a machine learning model. The feasibility determination may take into account various factors such as the traffic being high in the usual path to the friend's location, the post office being free right now and predicted by historical data to be likely crowded after 20 minutes etc.

Per sub-block 160, the method 100 includes selecting optimized task sequence. In other words, selecting the order of how the tasks are best executed (clean car, get coffee, go to post office, pick up friend, final destination).

In summary, the system 10 identifies relevant local platforms 30, connects to them based on the current requirements of a user 12 and obtains information from each to fulfill the requirements of the user 12 effectively. Various example scenarios are described herein. For example, the controller C may communicate with a home thermostat to switch on the air conditioner approximately 30 minutes before the user 12 reaches home; with this time changing dynamically based on traffic. In another example, where the smart home system 32 has a regular climate setting (e.g., thermostat) and a vacation climate setting, the controller C may be adapted to switch the smart home system 32 to the vacation climate setting when the vehicle is at least a predefined distance (e.g., 75 miles) away from the smart home system 32, along with satisfaction of other associated conditions.

In another example, the controller C is adapted to selectively grant access privileges of the smart home system 32 to a guest selected by the user 12. The access privileges may include access to the home Wi-Fi network and front door access to the home. In another example, where the local platforms 30 include a rented lodging facility having a host, the controller C may be adapted to receive electronic entrance access to the rented lodging facility from the host.

The central platform 22 may employ automatic identification of required information from local platforms, enabling seamless data integration across platforms. The central platform 22 may utilize the data integration to eliminate or rank options for users. This creates a more personalized experience while optimizing choices based on real-time information. The system 10 employs parameters-based dynamic dependency extraction and ontology building to structure key concepts, properties, and relationships within particular knowledge domains. Traffic conditions as well as factors such as availability, supply and demand dynamics, and dynamic pricing are taken in as inputs. The system 10 incorporates user points of interest (e.g., coffee shops, gyms, and charging stations) into planning the activities of the user 12.

Referring to FIG. 1, the various components of the system 10 may communicate via a wireless network 54, which may be a short-range network or a long-range network. The wireless network 54 may be a serial communication bus in the form of a local area network. The local area network may include, but is not limited to, a Command unit Area Network (MAY), a Command unit Area Network with Flexible Data Rate (MAY-FD), Ethernet, Bluetooth, WIFI and other forms of data. The wireless network 54 may be a Wireless Local Area Network (LAN) which links multiple devices using a wireless distribution method, a Wireless Metropolitan Area Network (MAN) which connects several wireless LANs or a Wireless Wide Area Network (WAN) which covers large areas such as neighboring towns and cities. Other types of network technologies or carrier systems available to those skilled in the art may be employed.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system for providing personalized assistance to a user of a vehicle, the system comprising:
a controller installed in the vehicle, the controller having a processor and tangible, non-transitory memory on which instructions are recorded;
a central platform in communication with the controller, the central platform being located remotely relative to the vehicle, the central platform being communicatively coupled to a plurality of local platforms having respective services;
a mobile application operable by the user and adapted to interface with the controller;
wherein the controller is adapted to transmit situational data to the central platform, including at least one of vehicle location data, vehicle status data, user preference data, and usage history data;
wherein the central platform is adapted to analyze the situational data to determine one or more service recommendations for the user offered by the plurality of local platforms;
wherein the controller is adapted to receive the one or more service recommendations from the central platform, the mobile application being adapted to solicit user input on the one or more service recommendations; and
wherein the controller is adapted to facilitate access of the user to the one or more service recommendations based on the user input.

2. The system of claim 1, wherein the vehicle includes an infotainment unit, the mobile application being hosted by the infotainment unit.

3. The system of claim 1, wherein the plurality of local platforms includes a charging station, a roadside unit, and a tolling unit.

4. The system of claim 3, wherein the plurality of local platforms includes a transportation hub, a lodging facility, and food service establishment.

5. The system of claim 4, wherein the plurality of local platforms includes a home system, a paid parking facility and another vehicle.

6. The system of claim 1, wherein the controller is adapted to:
identify the user and obtain an associated user profile;
extract trip details and personal requirements based in part on user input and/or historical data;
confirm the trip details with the user; and
identify a plurality of trip parameters, including at least one of toll avoidance, maximum waiting time, carpool constraints, and beverage pickup.

7. The system of claim 6, wherein the controller is adapted to:
extract one or more dependency relationships between the plurality of trip parameters through a large language model (LLM);
determine presence of a user override factor; and
select a respective optimal value for the plurality of trip parameters based on a user profile and the one or more dependency relationships.

8. The system of claim 1, wherein the controller is adapted to: solicit tasks to be accomplished within a predefined time from the user; and perform task sequencing for the tasks using a large language model (LLM).

9. The system of claim 8, wherein at least one of the tasks requires advanced booking and controller is adapted to make the advanced booking for the at least one of the tasks for the user via an electronic reservation protocol.

10. The system of claim 1, wherein the plurality of local platforms includes a home system having a regular climate setting and a vacation climate setting, the controller being adapted to switch the home system to the vacation climate setting when the vehicle is a predefined distance away from the home system.

11. The system of claim 1, wherein:
the plurality of local platforms includes a home system;
the controller is adapted to selectively grant access privileges of the home system to a guest selected by the user; and
the access privileges include access to at least one of a home Wi-Fi and front door access to the home system.

12. The system of claim 1, wherein the plurality of local platforms includes a rented lodging facility having a host and the controller being adapted to receive electronic entrance access to the rented lodging facility from the host.

13. The system of claim 1, wherein the central platform is adapted to communicate with the plurality of local platforms via a publish-subscribe messaging protocol, including Message Queue Telemetry Transport (MQTT).

14. A method for providing personalized assistance to a user of a vehicle having an infotainment unit and a controller with a processor and tangible, non-transitory memory on which instructions are recorded, the method comprising:
establishing bi-directional communication between a central platform and the controller, the central platform being located remotely relative to the vehicle, the central platform being communicatively coupled to a plurality of local platforms having respective services;
hosting a mobile application with the infotainment unit, the mobile application being operable by the user;
transmitting situational data from the controller to the central platform, the situational data including at least one of vehicle location data, vehicle status data, user preference data, and usage history data;
analyzing the situational data to determine one or more service recommendations for the user from the plurality of local platforms, via the central platform;
receiving the one or more service recommendations from the central platform, via the controller;
soliciting user input for the one or more service recommendations, via the mobile application; and
facilitating access of the user to the one or more service recommendations, via the controller.

15. The method of claim 14, further comprising:
identifying the user and obtaining an associated user profile;
extracting trip details and personal requirements based in part on user input and/or historical data;
confirming the trip details with the user; and
identifying a plurality of trip parameters, including at least one of toll avoidance, maximum waiting time, carpool constraints, and beverage pickup.

16. The method of claim 14, further comprising:
incorporating a home system with a regular climate setting and a vacation climate setting in the plurality of local platforms; and
switching the home system to the vacation climate setting when the vehicle is a predefined distance away from the home system, via the controller.

17. The method of claim 14, further comprising:
incorporating a home system in the plurality of local platforms; and
granting access privileges of the home system to a guest selected by the user, via the controller, the access privileges including access to at least one of a home Wi-Fi and front door access to the home system.

18. The method of claim 14, further comprising:
incorporating a rented lodging facility having a host in the plurality of local platforms; and
receiving electronic entrance access to the rented lodging facility from the host, via the controller.

19. A vehicle comprising:
a controller installed in the vehicle, the controller having a processor and tangible, non-transitory memory on which instructions are recorded;
a central platform in communication with the controller, the central platform being located remotely relative to the vehicle, the central platform being communicatively coupled to a plurality of local platforms having respective services;
an infotainment unit and a mobile application operable by a user, the mobile application being hosted by the infotainment unit;
wherein the controller is adapted to transmit situational data to the central platform, including at least one of vehicle location data, vehicle status data, user preference data, and usage history data;
wherein the central platform is adapted to communicate with the plurality of local platforms via a publish-subscribe messaging protocol;
wherein the central platform is adapted to analyze the situational data to determine one or more service recommendations for the user offered by the plurality of local platforms;
wherein the controller is adapted to receive the one or more service recommendations from the central platform, the mobile application being adapted to solicit user input on the one or more service recommendations; and
wherein the controller is adapted to facilitate access of the user to the one or more service recommendations based on the user input.

20. The vehicle of claim 19, wherein the plurality of local platforms includes a home system having a regular setting and a vacation setting, the controller being adapted to switch the home system to the vacation setting when the vehicle is a predefined distance away from the home system.
